(19) United States
(12) Patent Application Publication
(10) Pub. No.: US 2025/0001404 A1
(43) Pub. Date: Jan. 2, 2025

(54) Method of Synthesizing Aluminum-Rich Molecular Sieve of *MRE Framework Type

(71) Applicant: ExxonMobil Technology and Engineering Company, Baytown, TX (US)

(72) Inventors: Sina Sartipi, Willebroek (BE); Marc H. Anthonis, Vlaams Brabant (BE); Scott J. Weigel, Allentown, PA (US); Allen W. Burton, Stewartsville, NJ (US)

(21) Appl. No.: 18/251,641

(22) PCT Filed: Aug. 26, 2021
(86) PCT No.: PCT/US2021/047630

§ 371 Date: May 3, 2023

Related U.S. Application Data
(60) Provisional application No. 63/113,627, filed on Nov. 13, 2020.

(51) Int. Cl. B01J 29/70; B01J 37/04; B01J 37/08; C01B 39/02

(52) U.S. Cl. CPC B01J 29/703; B01J 37/04; B01J 37/08; C01B 39/02

(57) ABSTRACT

Disclosed is a method of synthesizing aluminum-rich molecular sieve of *MRE framework type, comprising the steps of preparing a synthesis mixture comprising at least one source of silica, at least one source of alumina having a low water solubility, at least one source of hydroxide ions, at least one source of alkali and/or alkaline earth metal M, at least one source of diquaternary alkylammonium structure directing agent R, water and optional seed crystals.

### CROSS REFERENCE TO RELATED APPLICATIONS

This application is a National Phase Application to PCT Application Serial No. PCT/US2021/047630 filed Aug. 26, 2021, which claims priority from U.S. Provisional Application No. 63/113,627, filed Nov. 134, 2020.

### FIELD OF THE INVENTION

The present invention relates to a method of synthesizing aluminum-rich molecular sieve of *MRE framework type and to a molecular sieve of *MRE framework type obtainable by said process.

### BACKGROUND OF THE INVENTION

Zeolites, both natural and synthetic, have been demonstrated in the past to be useful as adsorbents and to have catalytic properties for various types of hydrocarbon conversion reactions. Zeolites are ordered, porous crystalline materials having a definite crystalline structure as determined by X-ray diffraction (XRD). Within the crystalline zeolite material there are a large number of cavities which may be interconnected by a number of channels or pores. These cavities and pores are uniform in size within a specific zeolite material. Because the dimensions of these pores are such as to accept for adsorption molecules of certain dimensions while rejecting those of larger dimensions, these materials have come to be known as “molecular sieves” and are utilized in a variety of industrial processes, including within refinery processes and other processes for manipulating petroleum streams. Some molecular sieve or zeolite applications are catalytic in nature, while other applications focus on the ability of zeolites to selectively adsorb molecules within a gas stream.

One type of zeolite structure used for catalytic processing of petroleum streams is ZSM-48, which has orthorhombic or pseudo-orthorhombic symmetry and ten-ring non-interconnecting, linear channels whose ideal dimensions are 5.5×5.6 Å. The framework structure of ZSM-48 has been assigned the three-letter code *MRE. According to R. F. Lobo et al. (J. Am. Chem. Soc., 2002, 124, 13222-13230), ZSM-48 is not a code for one material but for a family of materials with different degrees of disorder. As a result, molecular sieves of the *MRE framework type can comprise zeolites of the ZSM-48 family such as at least one of COK-8, EU-2, EU-11, IZM-1, SSZ-91, ZBM-30, and ZSM-48.

As for many zeolites, the composition of the synthesis mixture used to form ZSM-48 (or other *MRE framework type molecular sieves) can have a strong impact on the crystalline structure and/or morphology of the resulting zeolites.

ZSM-48 has shown attractive properties as a catalyst, for instance for the dewaxing of hydrocarbon feedstocks, see for example U.S. Pat. Nos. 5,075,269, 6,884,339 and 6,984,309. As a result, there is considerable interest in finding new methods of synthesizing ZSM-48 and, in particular, ZSM-48 with high acid activity, that is, low silica to alumina molar ratio.

ZSM-48 was first synthesized by Rollmann et al. using a C₄ to C₁₂ organic diamine as a structure-directing agent, see U.S. Pat. No. 4,423,021. As synthesized by Rollman et al., the zeolite contained little or no aluminum and so had little acid activity.

U.S. Pat. No. 6,923,949 describes methods for forming ZSM-48 crystals using synthesis mixtures that include at least one organic template material selected from organic linear diquaternary alkyl ammonium compounds, e.g. hexamethonium chloride, and linear diamino alkanes, and non-ZSM-48 seed crystals. The resulting ZSM-48 crystals can have an X-ray diffraction pattern corresponding to ZSM-48, although the presence of the non-ZSM-48 seed crystals can be detected based on activity tests. For crystals having a silica to alumina ratio of about 70 to 1 to 150 to 1, the ZSM-48 crystals formed using non-ZSM-48 seeds are described as being small, irregularly shaped crystals that are free from fibrous morphology. For crystals with a silica to alumina ratio of less than 70 to 1, the ZSM-48 crystals are described as being mixtures of small, irregularly shaped crystals and needle morphology crystals.

U.S. Pat. No. 7,482,300 describes methods for forming ZSM-48 crystals without the use of non-ZSM-48 seeds in the synthesis mixture. The structure directing agent used for forming the ZSM-48 crystals is described as a hexamethonium salt, such as hexamethonium chloride. The resulting crystals can have a silica to alumina ratio from about 70 to 1 to about 110 to 1, and are described as being substantially free of fibrous morphology. Preferred ranges are also described for the molar ratio of OH⁻ to SiO₂ and the molar ratio of structure directing agent (or template) to SiO₂. The preferred ranges are described as suitable for formation of crystals that are substantially free of needle-like morphology crystals.

U.S. Pat. No. 8,003,074 describes methods for forming ZSM-48 crystals using a diquaternary ammonium salt structure directing agent with a 5 carbon atom alkyl chain between the ammonium ions (a “diquat-5” structure directing agent). Synthesis of ZSM-48 crystals using mixtures of a “diquat-5” structure directing agent and other structure directing agents, such as a “diquat-6” structure directing agent, is also described. Various types of synthesis mixtures are described that result in formation of fibrous and/or needle-like crystal morphologies.

U.S. Pat. No. 9,873,614 describes methods for forming substantially pure phase ZSM-48 crystals having a fiber or needle morphology, using synthesis mixtures containing non-sodium alkali metal ions and a diquaternary alkylammonium salt structure directing agent with a 6 carbon atom alkyl chain between the ammonium ions (“diquat-6”). The desired morphology can be achieved in part by reducing, minimizing, and/or eliminating the presence of sodium ions in the synthesis mixture.

As mentioned above, there is considerable interest in finding methods of synthesizing ZSM-48 having high acid activity, that is, low silica to alumina molar ratio. However, previous attempts to make ZSM-48 more aluminous often dramatically compromised the phase purity of the resulting ZSM-48 crystals. There is thus a continuous need to find new methods of synthesizing ZSM-48 having a low silica to alumina molar ratio, e.g. from synthesis mixtures having a SiO₂:Al₂O₃ molar ratio of less than 100 or even less than 80, while controlling the phase purity of the resulting ZSM-48 crystals.

### SUMMARY OF THE INVENTION

According to the present invention, it has now been found that aluminum-rich molecular sieve of *MRE framework type with controlled phase purity can be synthesized using alumina sources with low water solubility.

In a first aspect, the present invention therefore relates to a method of synthesizing aluminum-rich molecular sieve of *MRE framework type, the method comprising the steps of (a) preparing a synthesis mixture comprising at least one source of silica, at least one source of alumina with low water solubility, at least one source of hydroxide ions, at least one source of alkali metal M, at least one source of diquaternary alkylammonium structure directing agent R, water and optional seed crystals; (b) heating said synthesis mixture under crystallization conditions for a time sufficient to form molecular sieve of *MRE framework type; and (c) recovering said molecular sieve of *MRE framework type from the synthesis mixture. The synthesis mixture has the following molar ratio composition: SiO₂:Al₂O₃ from 15 to less than 100, OH⁻:SiO₂ from 0.02 to 0.8, M:SiO₂ from 0.02 to 0.8, R:SiO₂ from 0.005 to 0.5, and H₂O:SiO₂ from 5 to 100. Especially suitable of sources of alumina with low water solubility are for instance aluminum hydroxide and/or Kaolin, added to the synthesis mixture in solid form.

In a second aspect, the present invention also relates to an aluminum-rich molecular sieve of *MRE framework type, obtainable by or obtained by the process of the present invention.

In a third aspect, the present invention relates to the use an aluminum-rich molecular sieve of *MRE framework type, obtainable by or obtained by the process of the present invention, in a hydrocarbon chemical conversion process.

### BRIEF DESCRIPTION OF THE DRAWINGS

FIGS. 1A to 14A show the XRD spectra of each of Examples 1 to 14, respectively.

FIGS. 1B to 14B show Scanning Electron Microscopy (SEM) images of each of Examples 1 to 14, respectively.

FIG. 15 summarizes the reaction conditions and synthesis mixture molar ratios of Examples 1 to 14.

FIG. 16 summarizes the characteristics of the products obtained in Examples 1 to 14.

### DETAILED DESCRIPTION

As used herein, molecular sieves of the *MRE framework type comprise zeolites of the ZSM-48 family such as at least one of COK-8, EU-2, EU-11, IZM-1, SSZ-91, ZBM-30, and ZSM-48. In the following, the expressions “zeolite” and “molecular sieve” can be used interchangeably. Also, the expression “ZSM-48 family” is used synonymously with the expression “molecular sieve of *MRE framework type”. The term “ZSM-48 family” material as used herein, includes one or more of:
molecular sieves made from a common first degree crystalline building block unit cell, which unit cell has the *MRE framework topology (A unit cell is a spatial arrangement of atoms which if tiled in three-dimensional space describes the crystal structure. Such crystal structures are discussed in the “Atlas of Zeolite Framework Types,” Fifth edition, 2001, the entire content of which is incorporated as reference);
molecular sieves made from a common second degree building block, being a 2-dimensional tiling of such *MRE framework topology unit cells, forming a monolayer of one unit cell thickness, preferably one c-unit cell thickness;
molecular sieves made from common second degree building blocks, being layers of one or more than one unit cell thickness, wherein the layer of more than one unit cell thickness is made from stacking, packing, or binding at least two monolayers of one unit cell thickness. The stacking of such second degree building blocks can be in a regular fashion, an irregular fashion, a random fashion, or any combination thereof, and
molecular sieves made by any regular or random 2-dimensional or 3-dimensional combination of unit cells having the *MRE framework topology.

More particularly, molecular sieves of the *MRE framework type comprise a family of materials having straight channels (or tubular) pores. The pores are formed of rolled up honeycomb-like sheets of fused T6-rings (T=tetrahedral), and the pore aperture contains 10 T-atoms. Neighbouring pores are related by a zero shift along the pore direction or by a shift of half the repeat distance along the pore direction. Molecular sieves of the *MRE framework type generally have an X-ray diffraction pattern including d-spacing maxima at 11.8±0.2, 10.2±0.2, 7.2±0.15, 4.2±0.08, 3.9±0.08, 3.6±0.06, 3.1±0.05 and 2.85±0.05 Angstrom. The X-ray diffraction data used to characterize the material are obtained by standard techniques using the K-alpha doublet of copper as the incident radiation and a diffractometer equipped with a scintillation counter and associated computer as the collection system.

The method of synthesizing aluminum-rich molecular sieve of *MRE framework type according to the present invention involves preparing a synthesis mixture according to conventional techniques, except that the synthesis mixture comprises at least one source of alumina having a low water solubility. Preferably, the synthesis mixture only comprises source(s) of alumina having a low water solubility. The method of synthesizing a molecular sieve according to the invention further involves crystallizing the molecular sieve according to conventional techniques, and isolating the molecular sieve according to conventional techniques.

More particularly, the present invention relates to a method of synthesizing a molecular sieve of *MRE framework type, the method comprising the steps of: (a) preparing a synthesis mixture comprising at least one source of silica, at least one source of alumina with low water solubility, at least one source of hydroxide ions, at least one source of alkali metal M, at least one source of linear diquaternary alkylammonium structure directing agent R, water and optional seed crystals; (b) heating said synthesis mixture under crystallization conditions for a time sufficient to form a molecular sieve of *MRE framework type; and (c) recovering said molecular sieve of *MRE framework type from the synthesis mixture. The synthesis mixture has the following molar ratio composition: SiO₂:Al₂O₃ from 15 to less than 100, OH⁻:SiO₂ from 0.02 to 0.8, M:SiO₂ from 0.02 to 0.8, R:SiO₂ from 0.005 to 0.5, and H₂O:SiO₂ from 5 to 100. Especially suitable of sources of alumina with low water solubility are for instance aluminum hydroxide and/or Kaolin added to the synthesis mixture in solid form.

The present inventors have indeed found that the use of at least one source of alumina having a low water solubility allows for the preparation of aluminum-rich molecular sieve of *MRE framework type with improved control on the crystal phase purity. Without wishing to be bound by theory, the inventors believe that the use of at least one source of alumina having a low water solubility results in a slow release of the aluminum into the crystallization medium, in the course of the hydrothermal treatment, which results in an improved control of the phase purity of the aluminum-rich molecular sieve of *MRE framework type. It is also believed, without wishing to be bound by theory, that the slow release of the aluminum into the synthesis mixture helps keeping the concentration of alkali or alkaline earth metal low through the crystallization process. Said alkali or alkaline earth metals being known as structure directing agents for more condensed phases, keeping their concentration low through the crystallization process allows for a further improvement in control of the phase purity of the aluminum-rich molecular sieve of *MRE framework type.

The present invention also relates to an aluminum-rich molecular sieve of *MRE framework type, obtainable by the process of the present invention, in particular a molecular sieve of *MRE framework type having a SiO₂:Al₂O₃ molar ratio of less than 100.

### The Synthesis Mixture

The synthesis mixture can be prepared according to conventional methods, provided that at least one source of alumina is selected from a source of alumina having a low water solubility, such as from aluminum hydroxide or Kaolin in solid form.

The SiO₂:Al₂O₃ molar ratio in the synthesis mixture is typically at least 15, most often at least 20, in particular at least 25, such as at least 30, at least 40 or at least 50. The SiO₂:Al₂O₃ molar ratio in the synthesis mixture is typically less than 100, preferably less than 80, more preferably less than 75, such as less than 70, most often at least 20, in particular at least 25, such as at least 30, at least 40 or at least 50. For instance, the SiO₂:Al₂O₃ molar ratio in the synthesis mixture may be from 15 to less than 100, or from 20 to less than 100, or from 25 to less than 100, or from 30 to less than 100, in particular from 15, 20, 25, 30 or 40 to less than 80, or to less than 75 or to less than 70.

Effective amounts of the various components are added to form a synthesis mixture having the following molar composition:

| | Useful | Preferred | More Preferred |
|---|---|---|---|
| | Range | Range | Range |
| OH⁻:SiO₂ | 0.02 to 0.6 | 0.05 to 0.5 | 0.1 to 0.3 |
| M:SiO₂ | 0.02 to 0.6 | 0.05 to 0.5 | 0.1 to 0.3 |
| R:SiO₂ | 0.005 to 0.5 | 0.01 to 0.1 | 0.01 to 0.05 |
| H₂O:SiO₂ | 5 to 100 | 7 to 50 | 10 to 30 |

Many sources of alumina are known from the prior art, which generally teaches the preferred use of water soluble sources of alumina such as an aluminate, e.g. sodium aluminate, or an aluminum salt, e.g. a chloride, nitrate or sulfate aluminium salt. Prior art also often discloses the use of aluminium alcoholates or alumina, preferably in a hydrated or hydratable form, such as colloidal alumina, pseudoboehmite, boehmite, gamma alumina or a trihydrate, or aluminium hydroxide, which are typically added to the synthesis mixture after dissolution in a caustic solution such as sodium or potassium hydroxide. Contrary to the general teaching of the prior art, in the method of the present invention, the synthesis mixtures comprises at least one source of alumina having a low water solubility. In the present invention, the expression “source of alumina having a low water solubility” intends to denote sources of alumina that are not readily soluble in the synthesis mixture at room temperature (e.g., 20° C.) and near-neutral pH (e.g., pH 7) and that are not dissolved prior to their addition into the synthesis mixture, e.g., in a caustic solution. In the process of the present invention, the at least one source of alumina having a low water solubility is added to synthesis mixture in solid form by opposition to its addition in the form of a solution such as a solution in a caustic solution, e.g., in sodium hydroxide or potassium hydroxide.

In the process of the present invention, especially suitable sources of alumina having a low water solubility include aluminum hydroxide, clays selected from kaolin families, and metakaolin. Typical examples of appropriate solid form include powder form, for instance solid particles having a mean particle size of from 0.01 to 300 m, such as from 0.1 to 200 m or from 1 to 100 m, as volume weighted mean measured by dynamic light scattering (DLS). Clays selected from kaolin families are commonly known as Dixie, McNamee, Georgia and Florida clays, or others in which the main mineral constituent is kaolinite, halloysite, dickite, nacrite, or anauxite. Kaolinite, halloysite, dickite and nacrite are polymorph clay minerals with the empirical formula Al₂Si₂O₅(OH)₄. Anauxite is considered as a mixture of kaolinite and free silica. Metakaolin is obtained by dehydration of kaolin clays such as from kaolinite and can be described by formula Al₂Si₂O₇.

While other, typical, sources of alumina might also be present in the synthesis mixture, i.e. sources of alumina that are readily soluble in the synthesis mixture or in the form of a solution for instance in caustic solution, such typical sources of alumina should only be present in minor amounts, that is 10 mol % or less of the total sources of alumina in terms of total Al₂O₃ amount, in particular 5 mol % or less, more particularly 2 mol % or less. In an especially preferred embodiment of the present invention, the synthesis mixture contains essentially no additional sources of alumina, except the at least one source of alumina having a low water solubility as defined above.

Suitable sources of silica for use in the method of the present invention include any source of silica in normal use envisaged for zeolite synthesis. For example, suitable sources of silica include precipitated silica, e.g. Ultrasil® and Sipernat® 340 (available from Evonik), fumed silica, such as Aerosil® (available from Degussa) and Cabosil® (available from DMS), silica gels, silicic acid, silicates, e.g., tetraalkyl orthosilicates such as tetramethylorthosilicate, alkali metal silicates such as potassium silicate and sodium silicate, or an aqueous colloidal suspensions of silica, for example, that sold by E.I. du Pont de Nemours under the tradename Ludox®.

Traditionally, a variety of structure directing agents have been used for the synthesis of ZSM-48 crystals, including linear diquaternary alkylammonium structure directing agents. In the method of the present invention, the linear diquaternary alkylammonium structure directing agent R is typically the cation portion of the salt represented by the formula R₁—R₃—R₂, where R₁ and R₂ are the same or different and R₁ and R₂ are tetraalkylammonium groups having the formula —N+-RR′R″, and R₃ is be a polymethylene group of formula (CH₂)ₙ, where R, R′ and R″ can each be alkyl groups and can each be the same or different. The R, R′, and R″ alkyl groups on the tetraalkylammonium group can each be an alkyl group having from 1 to 10 carbons, and preferably 4 carbons or less, such as a methyl group or an ethyl group. n is advantageously 5 or 6. Especially suitable linear diquaternary alkylammonium structure directing agents R in the context of the present invention can be selected from the group consisting of pentamethonium cation ((CH₃)₃N⁺(CH₂)₅N⁺(CH₃)₃), “Me₆-diquat-5 cation”), hexamethonium cation ((CH₃)₃N⁺(CH₂)₆N⁺(CH₃)₃), “Me₆-diquat-6 cation”), and mixtures thereof. Suitable sources of said linear diquaternary alkylammonium compounds include their salts such as nitrate, sulfate, halide, especially chloride or bromide, and/or their hydroxide derivatives.

In the method of the present invention, the alkali or alkaline earth metal M may be selected from the group consisting of Na, K, Li, Ca, Mg, and mixtures thereof. In a preferred embodiment, M is an alkali metal cation selected from the group consisting of Na, K, Li and mixtures thereof, more preferably Na and/or K. The alkali or alkaline earth metal M is generally present in the synthesis mixture as the hydroxide, but can also be present in the form of sodium aluminate, sodium silicate, potassium silicate, or of salts such as NaCl, NaBr, sodium nitrate, KCl, KBr, potassium nitrate, LiCl, LiBr, LiI, lithium nitrate, or lithium sulfate, or a combination thereof. Most often, the alkali or alkaline earth metal M is present as its hydroxide, such as sodium hydroxide and/or potassium hydroxide.

The at least one source of hydroxide ions may be selected from the group consisting of alkali metal hydroxides, alkaline earth metal hydroxides, ammonium hydroxide, and mixtures thereof, such as from sodium hydroxide, potassium hydroxide, lithium hydroxide, calcium hydroxide, magnesium hydroxide, ammonium hydroxide, and mixtures thereof, most often potassium hydroxide and/or sodium hydroxide. Hydroxide can also be present as a counter ion of the structure directing agent, i.e., hydroxide form of the structure directing agent R, or by the use of aluminum hydroxide as alumina source.

The synthesis preferably contains seed crystals, typically zeolite seed crystals of a different or identical framework type as *MRE, for instance seed crystals selected from the group consisting of ZSM-48, ZSM-5, ZSM-11, ZSM-12, BEA, Beta, X and Y zeolite seed crystals, preferably ZSM-48 or BEA seed crystals, more preferably BEA seed crystals. When seed crystals are used, they are most often added to the synthesis mixture so as to be present in an amount of from 50 ppm by weight to 50,000 ppm by weight, based on the total weight of the synthesis mixture. In general, at least 50 or 100 ppm by weight of seed crystals is employed, preferably from 100 to 10,000 ppm by weight, more preferably from 500 to 6,000 ppm by weight, based on the total weight of the synthesis mixture. The term “seed crystals” means either a seed crystal or an agglomerate of seed crystals. For instance, the size of the seed crystals introduced in the synthesis mixture can range from 0.01 to 5.0 m, such as from 0.02 to 1.0 m. Optionally, the seed crystals are included in the synthesis mixture in the form of a colloidal suspension in a liquid medium, such as water. As used herein, the expression “colloidal suspension” refers to a suspension containing discrete finely divided particles dispersed in a continuous liquid phase; preferably, it refers to a suspension that is stable, in the sense that no visible separation occurs or sediment forms, in a period sufficient for the use intended, advantageously for at least 10 hours, more advantageously at least 20 hours, preferably at least 100 hours, and more preferably at least 500 hours at ambient temperature (23° C.). The maximum size of the particles for the suspension to remain stable (peptized) will depend to some extent on their shape, and on the nature and pH of the continuous medium, as well as on the period during which the suspension must remain usable. The particles may be spherical, or of other shapes. Where particles are other than spherical, the dimension referred to is their smallest dimension. The colloidal seeds generally have an average diameter (or smallest dimension, corresponding to the number-average primary particle size as determined by SEM for 100 or more particles) of 300 nm or less, in particular of 200 nm or less, more particularly of 100 nm or less, provided that said colloidal seeds form a stable suspension, in the sense that no visible separation occurs or sediment forms, in a period sufficient for the use intended.

The components of the synthesis mixture may be combined in any order. In a preferred variant, when the at least one source of alumina includes aluminum hydroxide, the aluminum hydroxide is first mixed with at least part of the water to form a dispersion before addition of the other components, for instance before addition of additional hydroxide ions, the alkali or alkaline earth metal M, the structure directing agent R, and the source of silica. In a preferred variant, when the at least one source of alumina includes Kaolin, the Kaolin may be first mixed with at least part of the water and/or with at least part of the hydroxide source and/or with at least part of the structure directing agent R, to form a dispersion, before addition of the other components, for instance before addition of the source of silica.

### Crystallization and Recovery

In the process of the present invention, the crystallization conditions of step (b) may include heating the synthesis mixture at a temperature of from 100° C. to 220° C., preferably of from 120° C. to 200° C., preferably from 140° C. to 180° C., more preferably from 150° C. to 170° C.

The synthesis mixture is maintained under effective crystallization conditions until the molecular sieve of *MRE framework type is formed. The crystallization time may vary depending on a number of factors, from a few minutes to many hours, typically for a period of from 10 to 200 hours, more typically from 12 to 160 hours, for instance from 20 to 120 hours, or until the reaction is over and zeolite crystals have formed. The crystallization time can be established by methods known in the art such as by sampling the synthesis mixture at various times and determining the yield and X-ray crystallinity of precipitated solid.

Crystallization step (b) can be carried out at either static or, preferably, stirred conditions in any suitable reactor vessel, continuous or batch type, such as for example, a polypropylene jar or a Teflon® bottle, an acid digestion vessel, a Teflon® lined or stainless steel autoclave, a plough shear mixer, or a reaction kettle, preferably a polypropylene jar, a Teflon® bottle, or a Teflon® lined or stainless steel autoclave.

In step (c), the molecular sieve of *MRE framework type produced in step (b) may be recovered from the synthesis mixture by any conventional means, such as by centrifugation or filtration. The molecular sieve of *MRE framework type is then typically washed with deionized water and recovered by centrifugation or filtration. Subsequent operations may include washing with water, drying, typically performed at a temperature of less than 250° C. such as from 100° C. to 200° C., calcining and ion exchange.

### The Recovered Molecular Sieve of *MRE Framework Type

The molecular sieve of *MRE framework type obtainable or obtained by the process of the present invention are aluminum-rich crystals, such as aluminum-rich ZSM-48 crystals. In the present invention, the expression “aluminum-rich crystals” intends to denote crystals having a high aluminum content, typically expressed as a silica to alumina (SiO₂:Al₂O₃) molar ratio of less than 100, in particular of less than 80, more particularly of less than 70. The molecular sieve of *MRE framework type obtainable by the method of the present invention has a SiO₂:Al₂O₃ molar ratio of at least 10, typically of at least 15, generally of at least 20, more generally of at least 25, such as at least 30, 40 or even 50. The molecular sieve of *MRE framework type obtainable by the method of the present invention thus may have a SiO₂:Al₂O₃ molar ratio of from 10 to less than 100, such as from 10 to less than 80 or from 10 to less than 70, for instance from 15 or 20 to less than 80, or from 15 or 20 to less than 70, or from 30 or 40 to less than 80, or from 30 or 40 to less than 70. It will be understood that the SiO₂:Al₂O₃ molar ratio is the molar ratio in the molecular sieve framework. Any suitable method can be used to verify the composition of a molecular sieve material, such as inductively coupled plasma optical emission spectrometry (ICP-OES) analysis.

It will be understood by a person skilled in the art that the molecular sieve of *MRE framework type obtained from the process of the present invention may contain impurities, such as amorphous materials; unit cells having non-*MRE framework topologies; unconverted kaolin; and/or other impurities (e.g., heavy metals and/or organic hydrocarbons). Typical examples of the non-*MRE framework type molecular sieve co-existing with the *MRE framework type molecular sieve of the present invention are Kenyaite, Magadiite, EU-1, ZSM-50, FAU, Zeolite P, ZSM-12, ZSM-5, Ferrierite, Mordenite, Sodalite, and/or Analcine. Other examples are molecular sieves having framework type of EUO, MTW, FER, MOR, SOD, ANA, and/or MFI. The *MRE framework type molecular sieve obtained by the process of the present invention are preferably substantially free of impurities. The term “substantially free of impurities” used herein means the *MRE framework type molecular sieve preferably contains a minor proportion such as 10 wt % or less, preferably 5 wt % or less, more preferably 2 wt % or less, even more preferably 1 wt % or less and most preferably no detectable amount by XRD of such impurities (or “non-*MRE framework type molecular sieve”), which weight percent (wt %) values are based on the combined weight of impurities and pure phase *MRE framework type molecular sieve. The amount of impurities can be appropriately determined by powder XRD, rotating electron diffraction, and/or SEM/TEM (e.g. different crystal morphologies).

Optionally, the molecular sieve of *MRE framework type obtainable or obtained by the process of the present invention has, in its calcined and ion-exchanged form, a S_{BET} surface area of from 150 to 500, such as 160 to 400, for example 170 to 350 m²/g. Optionally, the molecular sieve of *MRE framework type obtainable or obtained by the process of the present invention has, in its calcined and ion-exchanged form, a micropore volume (V_{micro}) of 0.04 to 0.2, for example 0.05 to 0.1 cm³/g.

### Subsequent Processing of the Molecular Sieve of *MRE Framework Type

As a result of the crystallization process, the recovered molecular sieve of *MRE framework type contains at least a portion of the structure directing agent R used in the synthesis within its pores. Preferably, the method therefore additionally comprises activating the molecular sieve to at least partially remove the structure directing agent from the molecular sieve. The activation process is typically accomplished by calcining, or essentially heating the molecular sieve comprising the structure directing agent in the presence of an oxygen-containing gas. In some cases, it may be desirable to heat the molecular sieve in an environment having a low or zero oxygen concentration. This type of process can be used for partial or complete removal of the structure directing agent from the intracrystalline pore system. In other cases, particularly with smaller structure directing agents, complete or partial removal from the sieve can be accomplished by conventional desorption processes. Typically, the recovered molecular sieve is subjected to a calcining step involving heating the material at a temperature of at least about 200° C., preferably at least about 300° C., more preferably at least about 370° C. for at least 1 minute and generally not longer than 20 hours. While subatmospheric pressure can be employed for the thermal treatment, atmospheric pressure is usually desired for reasons of convenience. The thermal treatment can be performed at a temperature up to about 925° C. For instance, the thermal treatment can be conducted at a temperature of from 300° C. to 600° C., for instance from 400° C. to 550° C., such as from 500° C. to 550° C., in the presence of an oxygen-containing gas, for example, in air and/or ozone.

The molecular sieve may also be subjected to an ion-exchange treatment, for example, with aqueous ammonium salts, such as ammonium nitrates, ammonium chlorides, and ammonium acetates, in order to remove remaining alkali metal cations and/or alkaline earth metal cations and to replace them with protons thereby producing the acid form of the molecular sieve. To the extent desired, the original cations of the as-synthesized material, such as alkali metal cations, can be replaced by ion exchange with other cations. Preferred replacing cations can include hydrogen ions, hydrogen precursor, e.g., ammonium ions and mixtures thereof. The ion exchange step may take place after the as-made molecular sieve is dried. The ion-exchange step may take place either before or after a calcination step.

The molecular sieve may also be subjected to other treatments such as steaming and/or washing with solvent. Such treatments are well-known to the skilled person and are carried out in order to modify the properties of the molecular sieve as desired.

Once the molecular sieve has been synthesized, it can be formulated into a product composition by combination with other materials, such as binders and/or matrix materials that provide additional hardness to the finished product. These other materials can be inert or catalytically active materials. Calcination, ion-exchange, steaming and/or washing can be performed on the as-synthesized molecular sieve and/or after the molecular sieve has been formulated into a product combination.

Where the molecular sieve of *MRE framework type obtainable or obtained by the process of the present invention is to be used as a catalyst, it may be desirable to combine the molecular sieve of *MRE framework type with another material that is resistant to the temperatures and other conditions employed during use in organic conversion processes. Such materials include catalytically active and inactive materials and synthetic or naturally occurring zeolites as well as inorganic materials such as clays, silica and/or metal oxides such as alumina, yttria, zirconia, gallium oxide, zinc oxide and mixtures thereof. The metal oxides may be either naturally occurring or in the form of gelatinous precipitates or gels including mixtures of silica and metal oxides. Use of a catalytically active material in conjunction with the molecular sieve of *MRE framework type produced by the method of the present invention may improve the conversion and/or selectivity of the catalyst in certain organic conversion processes. Inactive materials suitably serve as diluents to control the amount of conversion in a given process so that products can be obtained economically and without employing other means for controlling the rate of reaction. These materials may be incorporated into naturally occurring clays to improve the crush strength of the catalyst under commercial operating conditions. Naturally occurring clays which can be composited with the molecular sieve of *MRE framework type obtainable or obtained by the method of the present invention include montmorillonite and kaolin families, which families include the subbentonites and kaolins commonly known as Dixie, McNamee, Georgia and Florida clays, or others in which the main mineral constituent is halloysite, kaolinite, dickite, nacrite, or anauxite. Such clays can be used in the raw state as originally mined or after being subjected to calcination, acid treatment or chemical modification. Binders useful for compositing with the molecular sieve of *MRE framework type also include inorganic oxides, notably alumina. These materials, i.e., clays, oxides, etc., function as binders for the catalyst and are resistant to the temperatures and other conditions, e.g., mechanical attrition, which occur in various hydrocarbon separation processes. Thus the molecular sieve of *MRE framework type prepared by the method of the present invention may be used in the form of an extrudate with a binder. They are typically bound by forming a pill, sphere, or extrudate. The extrudate is usually formed by extruding the molecular sieve, optionally in the presence of a binder, and drying and calcining the resulting extrudate. Further treatments such as steaming, and/or ion exchange may be carried out as required. The molecular sieve may optionally be bound with a binder having a surface area of at least 100 m²/g, for instance at least 200 m²/g, optionally at least 300 m²/g.

In addition to the foregoing materials, the molecular sieve of *MRE framework type obtainable or obtained by the method of the present invention may be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

The relative proportions of molecular sieve of *MRE framework type and inorganic oxide matrix may vary widely, with the molecular sieve of *MRE framework type content ranging from about 1 to about 100 percent by weight and more usually, particularly when the composite is prepared in the form of extrudates, in the range of about 2 to about 95, optionally from about 20 to about 90 weight percent of the composite.

### Use of the Molecular Sieve of *MRE Framework Type

The molecular sieve of *MRE framework type obtainable or obtained by the method of the present invention can be used as an adsorbent, such as for separating at least one component from a mixture of components in the vapor or liquid phase having differential sorption characteristics with respect to the molecular sieve. Therefore, at least one component can be partially or substantially totally separated from a mixture of components having differential sorption characteristics with respect to the molecular sieve by contacting the mixture with the molecular sieve to selectively sorb the one component.

The molecular sieve of *MRE framework type obtainable or obtained by the method of the present invention can also be used in many hydrocarbon chemical conversion processes. Such catalyst applications include dewaxing, oligomerization, hydroisomerization such as hydroisomerization of normal paraffins, and isomerization such as olefin isomerization. Their use is especially advantageous in view of their high aluminum content which provides them with a high activity.

In catalyst applications, it may be desirable to employ the molecular sieve of *MRE framework type in combination with a metal component capable of providing the catalysts with a hydrogenation-dehydrogenation function. Suitable metal components include tungsten, vanadium, molybdenum, rhenium, nickel, cobalt, chromium, manganese, or a noble metal such as platinum or palladium. Such component can be exchanged into the composition, impregnated therein or physically intimately admixed therewith. Such component can be impregnated in or onto it such as, for example, by, in the case of platinum, treating with a solution containing platinum metal-containing ions. Thus, suitable platinum compounds include chloroplatinic acid, platinous chloride and various compounds containing the platinum amine complex.

Catalyst containing molecular sieve of *MRE framework type produced by the present process are particularly useful in the dewaxing of lube oil basestocks. Such feedstocks are wax-containing feeds that boil in the lubricating oil range, typically having a 10% distillation point greater than 650° F. (343° C.), measured by ASTM D 86 or ASTM D2887. Such feeds may be derived from a number of sources such as oils derived from solvent refining processes such as raffinates, partially solvent dewaxed oils, deasphalted oils, distillates, vacuum gas oils, coker gas oils, slack waxes, foots oils and the like, and Fischer-Tropsch waxes. Preferred feeds are slack waxes and Fischer-Tropsch waxes. Slack waxes are typically derived from hydrocarbon feeds by solvent or propane dewaxing. Slack waxes contain some residual oil and are typically deoiled. Foots oils are derived from deoiled slack waxes. Fischer-Tropsch waxes are prepared by the Fischer-Tropsch synthetic process.

Dewaxing conditions with such lube oil basestocks typically include temperatures of up to 426° C., such as from about 250° C. to about 400° C., for example from about 275° C. to about 350° C., pressures of from about 791 kPa to about 20786 kPa, such as from about 1480 kPa to about 17339 kPa, liquid hourly space velocities from about 0.1 to about 10 hr⁻¹, such as from about 0.1 to about 5 hr⁻¹ and hydrogen treat gas rates from about 45 to about 1780 m³/m³ (250 scf/B to 10000 scf/B), such as from about 89 to about 890 m³/m³ (500 scf/B to 5000 scf/B).

Catalysts containing molecular sieve of *MRE framework type produced by the present process can also be used for hydroisomerization of normal paraffins, particularly when provided with a hydrogenation component, e.g., platinum. Typically hydroisomerization is carried out at a temperature from about 100° C. to about 400° C., such as about 150° C. to about 300° C., with a liquid hourly space velocity between about 0.01 and about 2 hr⁻¹, such as between about 0.25 and about 0.50 hr⁻¹ employing hydrogen such that the hydrogen to hydrocarbon mole ratio is between about 1:1 and about 5:1.

Catalysts containing molecular sieve of *MRE framework type produced by the present process are also especially useful for olefin isomerization. Typical conditions include a temperature from about 250° C. to about 750° C., an olefin partial pressure from about 30 kPa to about 300 kPa, and a WSHV from about 0.5 to about 500 hr⁻¹.

### EXAMPLES

The present invention is further illustrated below without limiting the scope thereto.

In these examples, the X-ray diffraction (XRD) patterns of the as-synthesized materials were recorded on an X-Ray Powder Diffractometer (Bruker, D8 Discover or STOE, Stadi P Combi) using copper K-α radiation in the 20 range of 2 to 40 degrees.

The scanning electron microscopy (SEM) images of the as-synthesized materials were obtained on a FEI Company, Helios Nanolab G3 UC Scanning Electron Microscope.

Zeolite framework types of the as-synthesized materials were identified by comparison of their XRD patterns to those of known zeolite materials. SEM images were used to aid assessment of product purity—the presence of obviously different crystal morphologies in a SEM image can be an indication of impurities in the form of other crystalline materials. Such an approximate analysis can be especially useful in identifying the presence of formation of relatively minor amounts of crystalline impurities which may not be identifiable on product XRD patterns.

The following measurements were conducted on samples that were ion-exchanged and calcined. For each sample subjected to ion-exchange and calcination, the procedure used was as follows: the as-prepared sample was washed two times with a 1M ammonium nitrate solution and then calcined at 538° C. for 6 hours.

The SiO₂:Al₂O₃ molar ratios of the materials were determined by inductively coupled plasma (ICP) method.

The overall surface area (S_{BET}) of the materials was determined by the BET method as described by S. Brunauer, P. H. Emmett and E. Teller, J. Am. Chem. Soc., 1938, v. 60, pp 309, incorporated herein by reference, using nitrogen adsorption-desorption at liquid nitrogen temperature.

The micropore volume (V_{micro}) of the materials was determined by application of the t-plot model to the N₂ isotherm, as referenced in “Analytical Methods in Fine Particle Technology, P. A. Webb and C. Orr, Micrometrics Instrument Corporation, ISBN 0-9656783-0-X”, the contents of which are hereby incorporated by reference. Comparative examples 1 to 5 illustrate the use of sodium aluminate or potassium aluminate solutions as source of alumina. Examples 6 to 10 illustrate the use of kaolin as source of alumina and examples 11 to 13 illustrate the use of undissolved aluminum hydroxide as source of alumina.

### Example 1 (Comparative): Sodium Aluminate Solution—SiO₂:Al₂O₃=81

A sodium aluminate solution was prepared by dissolving sodium aluminate powder in water (9.1 wt % alumina, 6.6 wt % sodium oxide). 15.50 g water, 1.40 g of a sodium hydroxide solution (20.0 wt %), 1.62 g of a hexamethonium dichloride solution (24.7 wt %), 0.96 g of the sodium aluminate solution, 0.75 g of BEA seeds (16.7 wt % aqueous colloidal suspension, 5000 wt ppm by weight of the synthesis mixture) and 4.76 g of precipitated silica (Ultrasil® VN3) were added to a Teflon® liner. The mixture was stirred for 5 minutes after each addition and for 15 minutes after the last addition. The mixture was then treated under hydrothermal conditions at 165° C. for 24 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 80.57, OH⁻/SiO₂ 0.13, Na⁺/SiO₂ 0.13, R/SiO₂ 0.02, H₂O/SiO₂ 14.87.

The recovered material was identified as ZSM-48 with a SiO₂/Al₂O₃ molar ratio of 67.

### Example 2 (Comparative): Sodium Aluminate Solution—SiO₂:Al₂O₃=80

A sodium aluminate solution was prepared by dissolving sodium aluminate powder in water (9.1 wt % alumina, 6.6 wt % sodium oxide). 16.52 g water, 1.65 g of a sodium hydroxide solution (20.0 wt %), 1.34 g of a hexamethonium dichloride solution (24.7 wt %), 0.80 g of the sodium aluminate solution, 0.75 g of BEA seeds (16.7 wt % aqueous colloidal suspension, 5000 wt ppm by weight of the synthesis mixture) and 3.94 g of precipitated silica (Ultrasil® VN3) were added to a Teflon® liner. The mixture was stirred for 5 minutes after each addition and for 15 minutes after the last addition. The mixture was then treated under hydrothermal conditions at 160° C. for 28 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 80.00, OH⁻/SiO₂ 0.17, Na⁺/SiO₂ 0.17, R/SiO₂ 0.02, H₂O/SiO₂ 18.70.

The recovered material was identified as ZSM-48 with a SiO₂/Al₂O₃ molar ratio of 67.

### Example 3 (Comparative): Sodium Aluminate Solution—SiO₂:Al₂O₃=80

A sodium aluminate solution was prepared by dissolving aluminum hydroxide (Alcoa) in a sodium hydroxide solution. The mixture was heated until a clear solution was obtained. Water was added to obtain the following composition: 3.0 wt % aluminum hydroxide, 9.1 wt % sodium hydroxide.

14.33 g water, 0.14 g of a sodium hydroxide solution (40.0 wt %), 1.33 g of a hexamethonium dichloride solution (25.1 wt %), 3.94 g of the sodium aluminate solution, 1.28 g of BEA seeds (9.8 wt % aqueous colloidal suspension, 5000 wt ppm by weight of the synthesis mixture) and 3.99 g of precipitated silica (Ultrasil® VN3) were added to a Teflon® liner. The mixture was stirred for 5 minutes after each addition and for 15 minutes after the last addition. The mixture was then treated under hydrothermal conditions at 160° C. for 28 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 80.00, OH⁻/SiO₂ 0.25, Na⁺/SiO₂ 0.17, R/SiO₂ 0.02, H₂O/SiO₂ 18.70.

The recovered material was identified as ZSM-48 with a SiO₂/Al₂O₃ molar ratio of 63.

### Example 4 (Comparative): Sodium Aluminate Solution—SiO₂:Al₂O₃=70

A sodium aluminate solution was prepared by dissolving sodium aluminate powder in water (10.0 wt % alumina, 7.4 wt % sodium oxide). 13.01 g water, 3.24 g of a sodium hydroxide solution (10.0 wt %), 1.70 g of a hexamethonium dichloride solution (23.4 wt %), 1.01 g of the sodium aluminate solution, 1.28 g of BEA seeds (9.8 wt % aqueous colloidal suspension, 5000 wt ppm by weight of the synthesis mixture) and 4.75 g of precipitated silica (Ultrasil® VN3) were added to a Teflon® liner. The mixture was stirred for 5 minutes after each addition and for 15 minutes after the last addition. The mixture was then treated under hydrothermal conditions at 165° C. for 24 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 70.00, OH⁻/SiO₂ 0.15, Na⁺/SiO₂ 0.15, R/SiO₂ 0.02, H₂O/SiO₂ 14.87.

The recovered material was identified as Kenyaite.

### Example 5 (Comparative): Potassium Aluminate Solution—SiO₂—Al₂O₃=65

A potassium aluminate solution was prepared by dissolving aluminum hydroxide (Alcoa) in a potassium hydroxide solution. The mixture was heated until a clear solution was obtained. Water was added to obtain the following composition: 3.0 wt % aluminum hydroxide, 5.5 wt % potassium hydroxide.

11.91 g water, 1.10 g of potassium hydroxide solution (7.3 wt %), 1.51 g of a hexamethonium dichloride solution (25.0 wt %), 5.26 g of the potassium aluminate solution, 0.75 g of BEA seeds (16.7 wt % aqueous colloidal suspension, 5000 wt ppm by weight of the synthesis mixture) and 4.48 g of precipitated silica (Ultrasil® VN3) were added to a Teflon® liner. The mixture was stirred for 5 minutes after each addition and for 15 minutes after the last addition. The mixture was then treated under hydrothermal conditions at 160° C. for 125 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 65.00, OH⁻/SiO₂ 0.19, K⁺/SiO₂ 0.10, R/SiO₂ 0.02, H₂O/SiO₂ 16.00.

The recovered material was identified as a mixture of ZSM-48 with significant amounts of EU-1 and some amorphous compounds.

### Example 6: Kaolin—SiO₂:Al₂O₃=81

13.75 g water, 1.81 g of a sodium hydroxide solution (20.0 wt %), 1.62 g of a hexamethonium dichloride solution (24.7 wt %), 2.42 g of a Kaolin mixture (10 wt % Kaolin powder dispersed in water, particle size about 5 m)), 0.75 g of BEA seeds (16.7 wt % aqueous colloidal suspension, 5000 wt ppm by weight of the synthesis mixture) and 4.64 g of precipitated silica (Ultrasil® VN3) were added to a Teflon® liner. The mixture was stirred for 5 minutes after each addition and for 15 minutes after the last addition. The mixture was then treated under hydrothermal conditions at 165° C. for 24 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 80.57, OH⁻/SiO₂ 0.13, Na⁺/SiO₂ 0.13, R/SiO₂ 0.02, H₂O/SiO₂ 14.87.

The recovered material was identified as ZSM-48 with a SiO₂/Al₂O₃ molar ratio of 76.

### Example 7: Kaolin—SiO₂:Al₂O₃=80

15.06 g water, 1.99 g of a sodium hydroxide solution (20.0 wt %), 1.34 g of a hexamethonium dichloride solution (24.7 wt %), 2.02 g of a Kaolin mixture (10 wt % Kaolin powder dispersed in water, particle size about 5 m), 0.75 g of BEA seeds (16.7 wt % aqueous colloidal suspension, 5000 wt ppm by weight of the synthesis mixture) and 3.84 g of precipitated silica (Ultrasil® VN3) were added to a Teflon® liner. The mixture was stirred for 5 minutes after each addition and for 15 minutes after the last addition. The mixture was then treated under hydrothermal conditions at 160° C. for 28 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 80.00, OH⁻/SiO₂ 0.17, Na⁺/SiO₂ 0.17, R/SiO₂ 0.02, H₂O/SiO₂ 18.70.

The recovered material was identified as ZSM-48 with a SiO₂/Al₂O₃ molar ratio of 68.

### Example 8: Kaolin—SiO₂:Al₂O₃=70

13.15 g water, 2.10 g of a sodium hydroxide solution (20.0 wt %), 1.60 g of a hexamethonium dichloride solution (25.0 wt %), 2.80 g of a Kaolin mixture (10 wt % Kaolin powder dispersed in water, particle size about 5 μm), 0.75 g of BEA seeds (16.7 wt % aqueous colloidal suspension, 5000 wt ppm by weight of the synthesis mixture) and 4.61 g of precipitated silica (Ultrasil® VN3) were added to a Teflon® liner. The mixture was stirred for 5 minutes after each addition and for 15 minutes after the last addition. The mixture was then treated under hydrothermal conditions at 165° C. for 24 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 70.00, OH⁻/SiO₂ 0.15, Na⁺/SiO₂ 0.15, R/SiO₂ 0.02, H₂O/SiO₂ 14.87.

The recovered material was identified as ZSM-48 with a SiO₂/Al₂O₃ molar ratio of 65.

### Example 9: Kaolin—SiO₂:Al₂O₃=65

13.20 g water, 1.81 g of a sodium hydroxide solution (20.0 wt %), 1.60 g of a hexamethonium dichloride solution (25.0 wt %), 3.03 g of a Kaolin mixture (10 wt % Kaolin powder dispersed in water, particle size about 5 m), 0.75 g of BEA seeds (16.7 wt % aqueous colloidal suspension, 5000 wt ppm by weight of the synthesis mixture) and 4.61 g of precipitated silica (Ultrasil® VN3) were added to a Teflon® liner. The mixture was stirred for 5 minutes after each addition and for 15 minutes after the last addition. The mixture was then treated under hydrothermal conditions at 165° C. for 24 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 65.00, OH⁻/SiO₂ 0.13, Na⁺/SiO₂ 0.13, R/SiO₂ 0.02, H₂O/SiO₂ 14.87.

The recovered material was identified as ZSM-48 with traces of Mordenite and a SiO₂/Al₂O₃ molar ratio of 61.

### Example 10: Kaolin—SiO₂:Al₂O₃=60

12.95 g water, 1.81 g of a sodium hydroxide solution (20.0 wt %), 1.60 g of a hexamethonium dichloride solution (25.0 wt %), 3.30 g of a Kaolin mixture (10 wt % Kaolin powder dispersed in water, particle size about 5 m), 0.75 g of BEA seeds (16.7 wt % aqueous colloidal suspension, 5000 wt ppm by weight of the synthesis mixture) and 4.59 g of precipitated silica (Ultrasil® VN3) were added to a Teflon® liner. The mixture was stirred for 5 minutes after each addition and for 15 minutes after the last addition. The mixture was then treated under hydrothermal conditions at 165° C. for 24 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 60.00, OH⁻/SiO₂ 0.13, Na⁺/SiO₂ 0.13, R/SiO₂ 0.02, H₂O/SiO₂ 14.87.

The recovered material was identified as ZSM-48 with traces of Mordenite and a SiO₂/Al₂O₃ molar ratio of 55.

### Example 11: Kaolin—SiO₂:Al₂O₃=50

385.60 g water, 47.57 g of a sodium hydroxide solution (19.5 wt %), 41.58 g of a hexamethonium dichloride solution (25.0 wt %), 10.29 g of a Kaolin mixture (10 wt % Kaolin powder dispersed in water, particle size about μm), 45.69 g of BEA seeds (7.1 wt % aqueous colloidal suspension, 5000 wt ppm by weight of the synthesis mixture) and 119.38 g of precipitated silica (Ultrasil® VN3) were added to a Teflon® liner. The mixture was stirred after each addition. A portion of the mixture was then treated under hydrothermal conditions at 165° C. for 24 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 50.00, OH⁻/SiO₂ 0.13, Na⁺/SiO₂ 0.13, R/SiO₂ 0.02, H₂O/SiO₂ 14.87.

The recovered material was identified as ZSM-48 with a SiO₂/Al₂O₃ molar ratio of 45.

### Example 12: Aluminum Hydroxide—SiO₂:Al₂O₃=65

0.16 g of aluminum hydroxide (particle size about 50 m), 13.49 g water, 4.90 g of a potassium hydroxide solution (7.3 wt %), 1.47 g of a hexamethonium dichloride solution (25.0 wt %), 0.80 g of BEA seeds (9.8 wt % aqueous colloidal suspension, 5000 wt ppm by weight of the synthesis mixture) and 4.27 g of precipitated silica (Ultrasil® VN3) were added to a Teflon® liner. The mixture was stirred for 5 minutes after each addition and for 15 minutes after the last addition. The mixture was then treated under hydrothermal conditions at 160° C. for 100 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 65.00, OH⁻/SiO₂ 0.19, K⁺/SiO₂ 0.10, R/SiO₂ 0.02, H₂O/SiO₂ 17.00.

The recovered material was identified as ZSM-48 with a SiO₂/Al₂O₃ molar ratio of 57.

### Example 13: Aluminum Hydroxide—SiO₂:Al₂O₃=50

0.22 g of aluminum hydroxide (particle size about 50 m), 16.38 g water, 3.83 g of a potassium hydroxide solution (7.3 wt %), 1.63 g of a hexamethonium dichloride solution (25.0 wt %), 0.82 g of BEA seeds (9.8 wt % aqueous colloidal suspension, 5000 wt ppm by weight of the synthesis mixture) and 4.71 g of precipitated silica (Ultrasil® VN3) were added to a Teflon® liner. The mixture was stirred for 5 minutes after each addition and for 15 minutes after the last addition. The mixture was then treated under hydrothermal conditions at 160° C. for 100 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 50.00, OH⁻/SiO₂ 0.19, K⁺/SiO₂ 0.07, R/SiO₂ 0.02, H₂O/SiO₂ 17.00.

The recovered material was identified as ZSM-48 with a SiO₂/Al₂O₃ molar ratio of 53.

### Example 14: Aluminum Hydroxide—SiO₂:Al₂O₃=50

0.21 g of aluminum hydroxide (particle size about 50 m), 17.46 g water, 1.67 g of a sodium hydroxide solution (20.0 wt %), 1.67 g of a hexamethonium dichloride solution (25.0 wt %), 0.79 g of BEA seeds (9.8 wt % aqueous colloidal suspension, 5000 wt ppm by weight of the synthesis mixture) and 4.38 g of precipitated silica (Ultrasil® VN3) were added to a Teflon® liner. The mixture was stirred for 5 minutes after each addition and for 15 minutes after the last addition. The mixture was then treated under hydrothermal conditions at 160° C. for 100 hours while stirring with a U-type stirrer. The solid material was recovered afterwards, washed several times with water, and dried at 120° C.

The synthesis mixture was as follows (synthesis mixture/molar ratios):
SiO₂/Al₂O₃ 50.00, OH⁻/SiO₂ 0.22, Na⁺/SiO₂ 0.10, R/SiO₂ 0.02, H₂O/SiO₂ 17.00.

The recovered material was identified as ZSM-48 with traces of impurities, with a SiO₂/Al₂O₃ molar ratio of 46.

### Example 15: Characterization of the Products of Examples 1-14

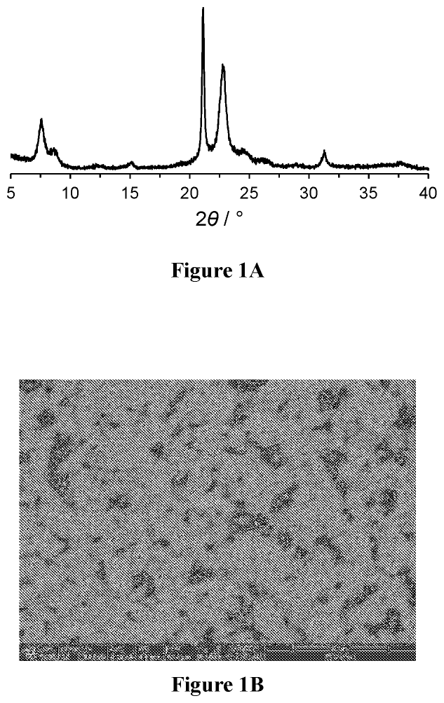

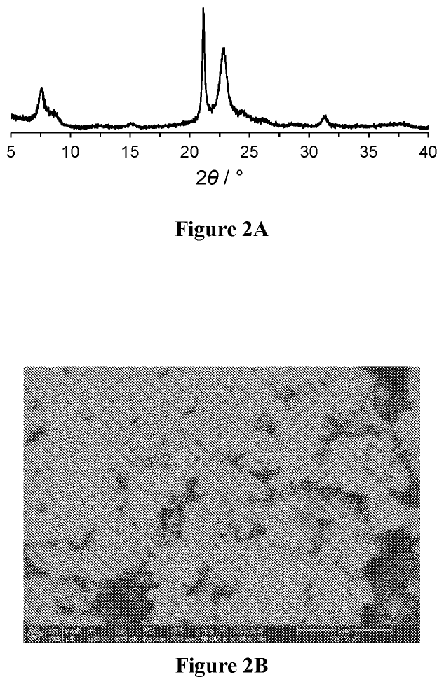

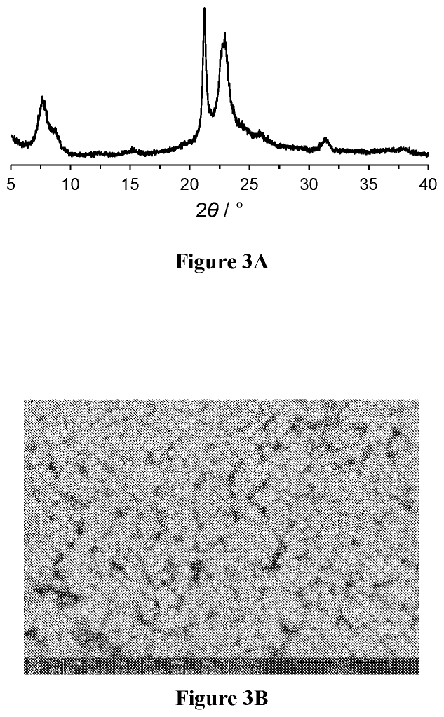

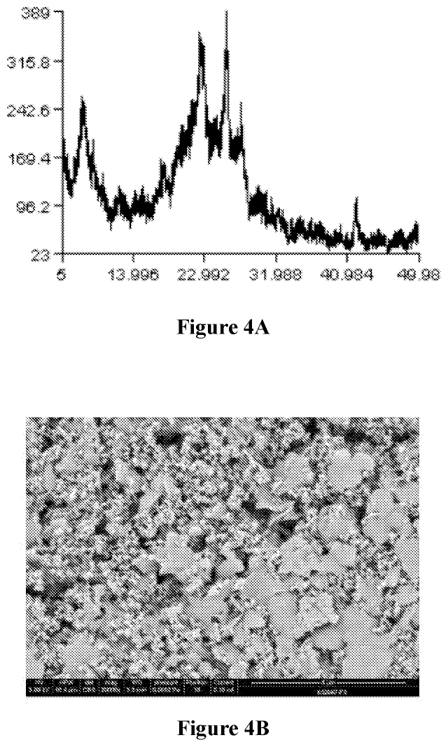

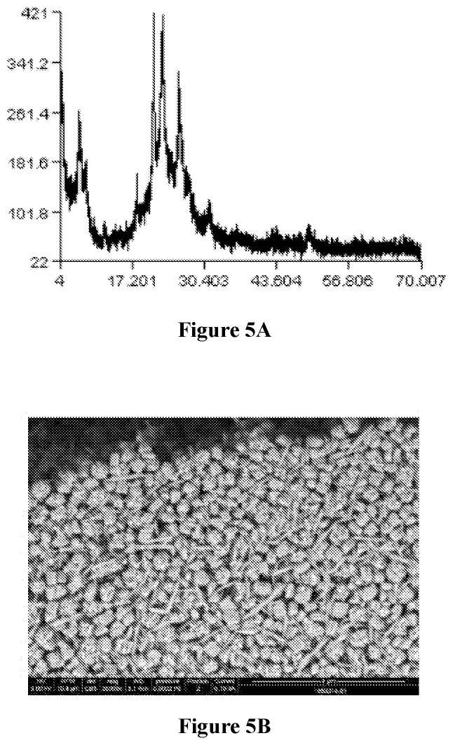

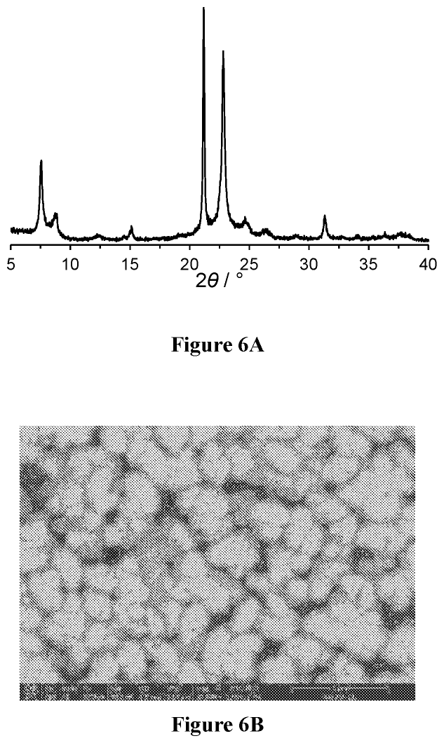

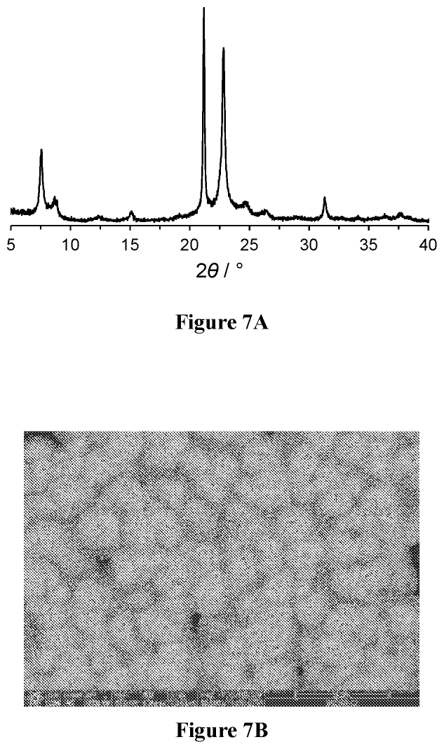

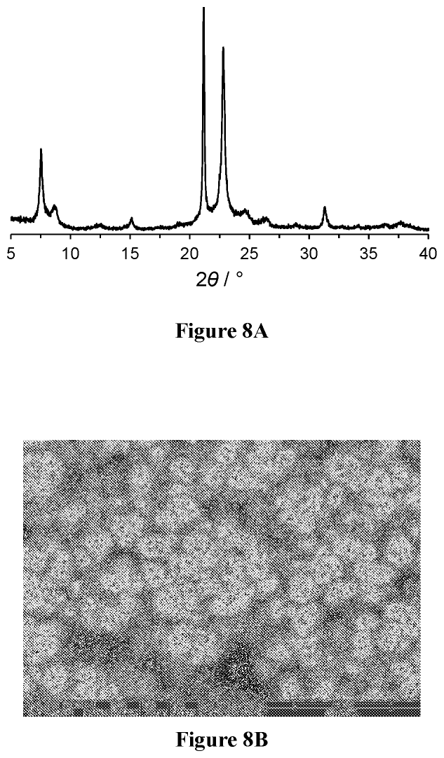

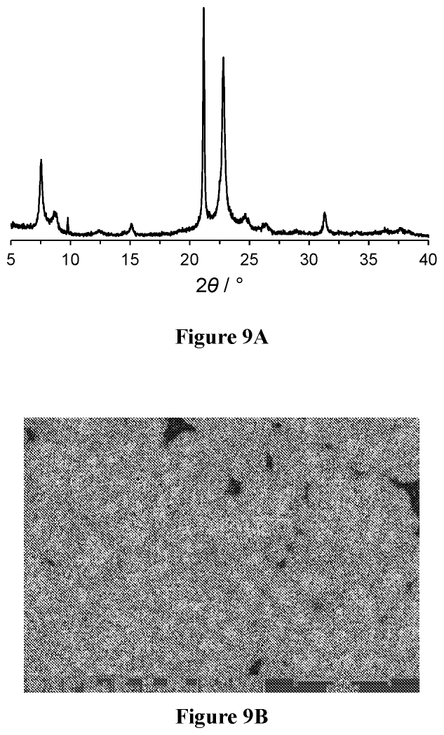

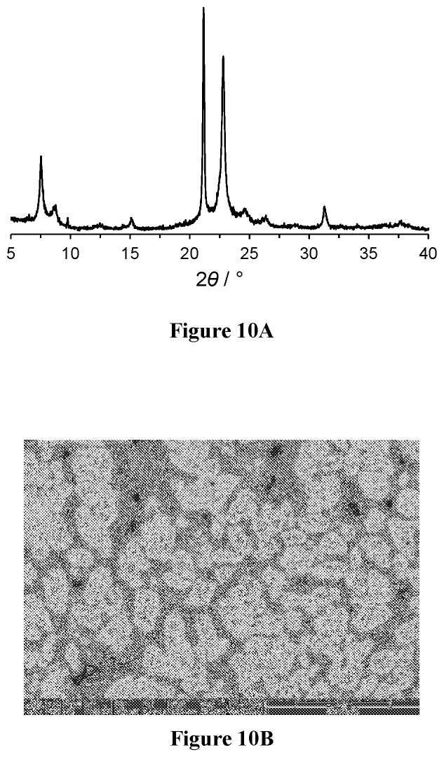

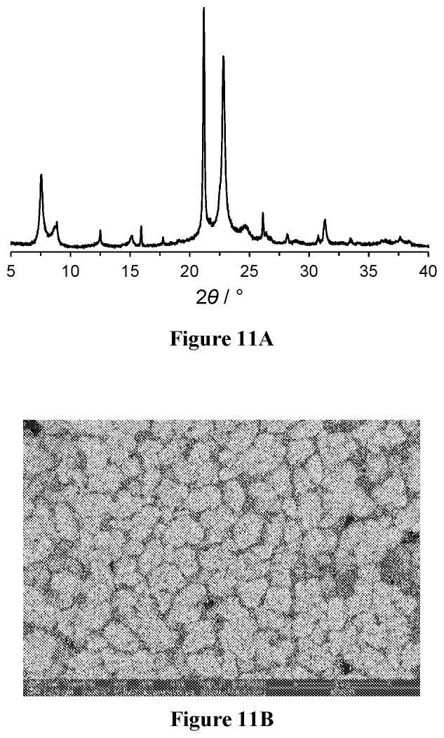

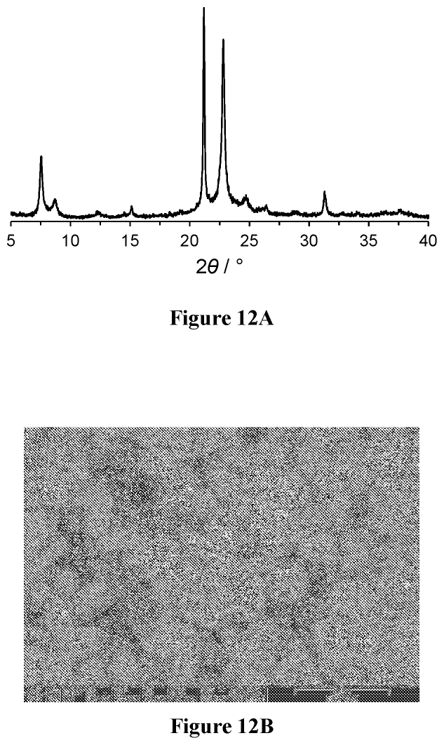

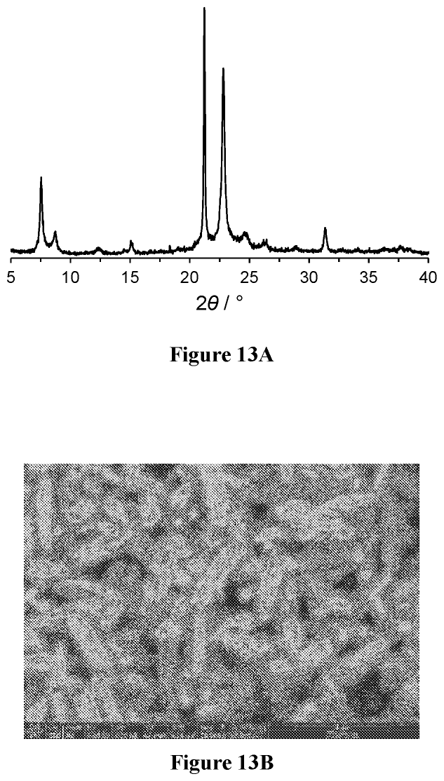

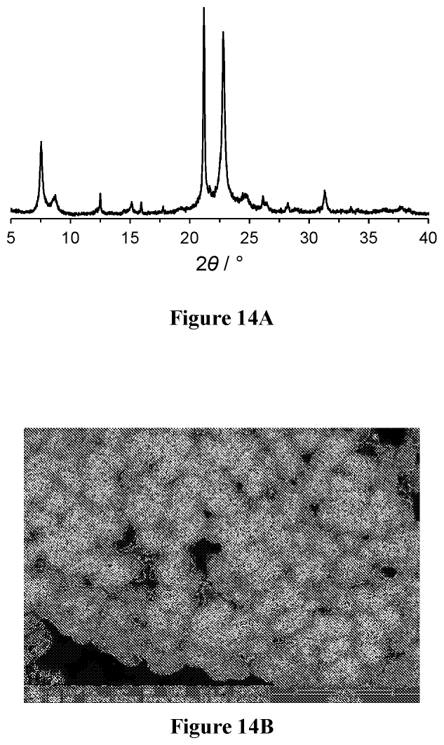

FIGS. 1A-14A show the XRD spectra of each of Examples 1 to 14, respectively (as-synthesized form).

FIGS. 1B to 14B show Scanning Electron Microscopy (SEM) images of each of Examples 1 to 14, respectively (as-synthesized form).

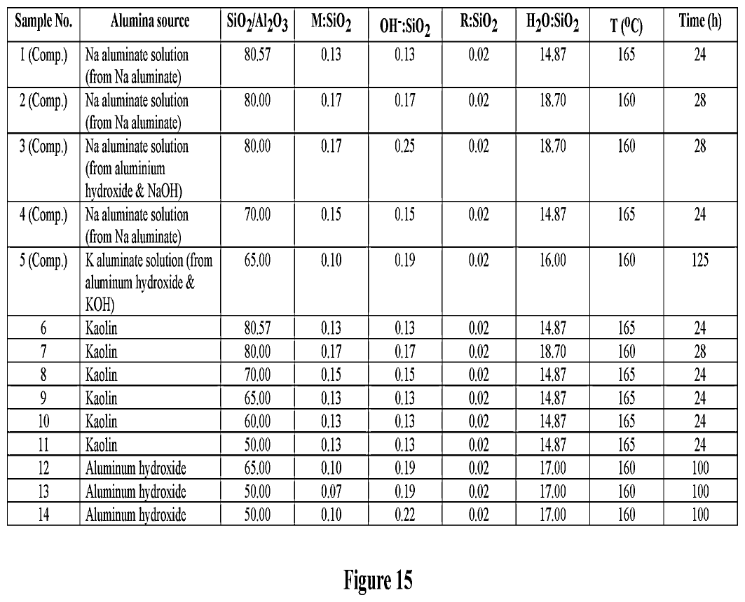

FIG. 15 summarizes the reaction conditions and synthesis mixture molar ratios for Examples 1 to 14.

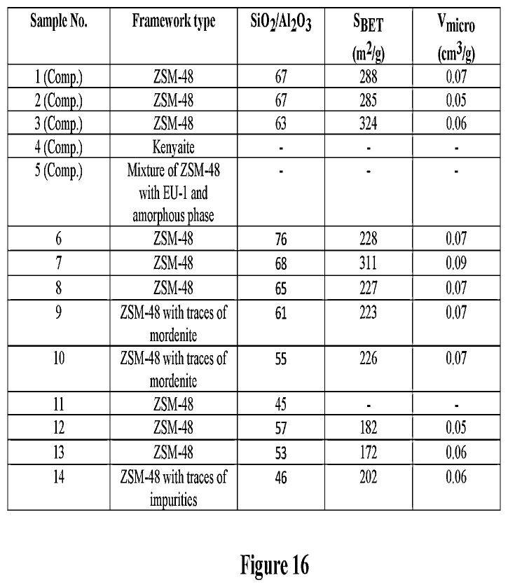

FIG. 16 summarizes the characteristics of the products obtained in Examples 1 to 14, i.e. their framework type, silica to alumina ratio, S_{BET} total surface area and micropore volume (V_{micro}).

While the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

Additionally or alternately, the invention relates to:

Embodiment 1: A method of synthesizing a molecular sieve of *MRE framework type, the method comprising the steps of
a) preparing a synthesis mixture comprising at least one source of silica, at least one source of alumina selected from aluminum hydroxide, clays selected from kaolin families, and metakaolin, at least one source of hydroxide ions, at least one source of alkali and/or alkaline earth metal M, at least one source of linear diquaternary alkylammonium structure directing agent R, water and optional seed crystals, the synthesis mixture having the following molar ratio composition: SiO₂:Al₂O₃ of 15 to less than 100, OH⁻:SiO₂ of 0.02 to 0.6, M:SiO₂ of 0.02 to 0.6, R:SiO₂ of 0.005 to 0.5, H₂O:SiO₂ of 5 to 100;
b) heating said synthesis mixture under crystallization conditions for a time sufficient to form a molecular sieve of *MRE framework type; and
c) recovering said molecular sieve of *MRE framework type from the synthesis mixture;
wherein the at least one source of alumina is added to the synthesis mixture in solid form.

Embodiment 2: The method of embodiment 1, wherein the molecular sieve of *MRE framework type is selected from the group consisting of COK-8, EU-2, EU-11, IZM-1, SSZ-91, ZBM-30, ZSM-48, and mixtures thereof, preferably wherein the molecular sieve of *MRE framework type is ZSM-48.

Embodiment 3: The method of embodiment 1 or 2, wherein the at least one source of alumina is in powder form, preferably in the form of solid particles having a mean particle size of from 0.01 to 300 m, preferably from 0.1 to 200 m, more preferably from 1 to 100 m, as volume weighted mean measured by dynamic light scattering (DLS).

Embodiment 4: The method of any one of embodiments 1 to 3, wherein the at least one source of silica is selected from the group consisting of precipitated silica, fumed silica, silica gels, silicic acid, tetraalkyl orthosilicates, alkali metal silicates and aqueous colloidal suspensions of silica.

Embodiment 5: The method of any one of embodiments 1 to 4, wherein the linear diquaternary alkylammonium structure directing agent R is selected from the group consisting of pentamethonium cation, hexamethonium cation, and mixtures thereof.

Embodiment 6: The method of any one of embodiments 1 to 5, wherein the alkali or alkaline earth metal M is selected from the group consisting of Na, K, Li, Ca, Mg, and mixtures thereof, preferably Na and/or K.

Embodiment 7: The method of any one of embodiments 1 to 6, wherein the at least one source of hydroxide ions is selected from the group consisting of alkali metal hydroxides, alkaline earth metal hydroxides, ammonium hydroxide, aluminum hydroxide, hydroxide form of the structure directing agent R, and mixtures thereof; preferably from sodium hydroxide, potassium hydroxide, lithium hydroxide, calcium hydroxide, magnesium hydroxide, ammonium hydroxide, aluminum hydroxide, hydroxide form of the structure directing agent R, and mixtures thereof; more preferably potassium hydroxide and/or sodium hydroxide.

Embodiment 8: The method of any one of embodiments 1 to 7, wherein the seed crystals are selected from the group consisting of ZSM-48, ZSM-5, ZSM-11, ZSM-12, BEA, Beta, X and Y zeolite seed crystals, preferably ZSM-48 or BEA seed crystals.

Embodiment 9: The method of any one of claims 1 to 8, wherein the seed crystals are present in an amount of from 0 to 50,000 ppm by weight, preferably from 50 to 10,000 ppm by weight, more preferably from 100 to 10,000 ppm by weight, most preferably from 500 to 6,000 ppm by weight, based on the total weight of the synthesis mixture.

Embodiment 10: The method of any one of embodiments 1 to 9, wherein the SiO₂:Al₂O₃ molar ratio in the synthesis mixture is from 15 to less than 100, preferably from 20 to less than 100, more preferably from 30 to less than 100, in particular to less than 80, or to less than 75 or to less than 70.

Embodiment 11: The method of any one of embodiments 1 to 10, wherein the synthesis mixture has a molar ratio composition in terms of OH⁻:SiO₂ of from 0.05 to 0.5, preferably 0.1 to 0.3.

Embodiment 12: The method of any one of embodiments 1 to 11, wherein the synthesis mixture has a molar ratio composition in terms of M:SiO₂ of from 0.05 to 0.5, preferably 0.1 to 0.3.

Embodiment 13: The method of any one of embodiments 1 to 12, wherein the synthesis mixture has a molar ratio composition in terms of R:SiO₂ of from 0.01 to 0.1, preferably 0.01 to 0.05.

Embodiment 14: The method of any one of embodiments 1 to 13, wherein the synthesis mixture has a molar ratio composition in terms of H₂O:SiO₂ of from 7 to 50, preferably 10 to 30.

Embodiment 15: The method of any one of embodiments 1 to 14, wherein the crystallization conditions in step (b) include a temperature of from 100° C. to 220° C. of from 120° C. to 200° C., preferably from 150° C. to 170° C. for a time of from 10 to 600 hours, in particular from 12 to 160 hours, especially from 20 to 120 hours.

Embodiment 16: Molecular sieve of *MRE framework type, obtainable by the process of any one of embodiments 1 to 15, having a SiO₂:Al₂O₃ molar ratio of from 10 to less than 100, preferably from 15 to less than 80, more preferably from 20 to less than 70.

Embodiment 17: Use of the molecular sieve of embodiment 16 in a hydrocarbon chemical conversion process, in particular wherein the hydrocarbon chemical conversion process is dewaxing, oligomerization, hydroisomerization or isomerization.

1-14. (canceled)

15. A method of synthesizing a molecular sieve of *MRE framework type, the method comprising:
a) preparing a synthesis mixture comprising at least one source of silica, at least one source of alumina selected from aluminum hydroxide, clays selected from kaolin families, and metakaolin, at least one source of hydroxide ions, at least one source of alkali and/or alkaline earth metal M, at least one source of linear diquaternary alkylammonium structure directing agent R, water and optional seed crystals, the synthesis mixture having the following molar ratio composition:

| | |
|---|---|
| SiO₂:Al₂O₃ | 15 to less than 100, |
| OH⁻:SiO₂ | 0.02 to 0.6, |
| M:SiO₂ | 0.02 to 0.6, |
| R:SiO₂ | 0.005 to 0.5, |
| H₂O:SiO₂ | 5 to 100; |

b) heating said synthesis mixture under crystallization conditions for a time sufficient to form a molecular sieve of *MRE framework type; and
c) recovering said molecular sieve of *MRE framework type from the synthesis mixture;
wherein the at least one source of alumina is added to the synthesis mixture in solid form.

16. The method of claim 15, wherein the molecular sieve of *MRE framework type is selected from the group consisting of COK-8, EU-2, EU-11, IZM-1, SSZ-91, ZBM-30, ZSM-48, and mixtures thereof.

17. The method of claim 15, wherein the molecular sieve of *MRE framework type is ZSM-48.

18. The method of claim 15, wherein the at least one source of alumina is in powder form, in a form of solid particles having a mean particle size of from 0.01 to 300 m, as volume weighted mean measured by dynamic light scattering (DLS).

19. The method of claim 15, wherein the at least one source of silica is selected from the group consisting of precipitated silica, fumed silica, silica gels, silicic acid, tetraalkyl orthosilicates, alkali metal silicates and aqueous colloidal suspensions of silica.

20. The method of claim 15, wherein the linear diquaternary alkylammonium structure directing agent R is selected from the group consisting of pentamethonium cation, hexamethonium cation, and mixtures thereof.

21. The method of claim 15, wherein the alkali or alkaline earth metal M is selected from the group consisting of Na, K, Li, Ca, Mg, and mixtures thereof.

22. The method of claim 15, wherein the at least one source of hydroxide ions is selected from the group consisting of alkali metal hydroxides, alkaline earth metal hydroxides, ammonium hydroxide, aluminum hydroxide, hydroxide form of the structure directing agent R, and mixtures thereof.

23. The method of claim 15, wherein the seed crystals are selected from the group consisting of ZSM-48, ZSM-5, ZSM-11, ZSM-12, BEA, Beta, X and Y zeolite seed crystals.

24. The method of claim 15, the seed crystals are ZSM-48 or BEA seed crystals.

25. The method of claim 15, wherein the seed crystals are present in an amount of from 0 to 50,000 ppm by weight, based on the total weight of the synthesis mixture.

26. The method of claim 15, wherein the SiO₂:Al₂O₃ molar ratio in the synthesis mixture is from 20 to less than 100.

27. The method of claim 15, wherein the synthesis mixture has a molar ratio composition of

| | |
|---|---|
| OH⁻:SiO₂ | 0.05 to 0.5, |
| M:SiO₂ | 0.05 to 0.5, |
| R:SiO₂ | 0.01 to 0.1, |
| H₂O:SiO₂ | 7 to 50. |

28. The method of claim 15, wherein the synthesis mixture has a molar ratio composition of

| | |
|---|---|
| OH⁻:SiO₂ | 0.1 to 0.3, |
| M:SiO₂ | 0.1 to 0.3, |
| R:SiO₂ | 0.01 to 0.05, |
| H₂O:SiO₂ | 10 to 30. |

29. The method of claim 15, wherein the crystallization conditions in step (b) include a temperature of from 100° C. to 220° C. for a time of from 10 to 600 hours.

30. A molecular sieve of *MRE framework type, obtainable by the method of claim 1, having a SiO₂:Al₂O₃ molar ratio of from 10 to less than 100.
